(19) United States
(12) Patent Application Publication
(10) Pub. No.: US 2026/0048467 A1
(43) Pub. Date: Feb. 19, 2026

(54) TOOL FOR HOLDING A TUNGSTEN ELECTRODE DURING SHARPENING

(71) Applicant: EDWIN ALONZO MARTINEZ, PASADENA, TX (US)

(72) Inventor: EDWIN ALONZO MARTINEZ, PASADENA, TX (US)

(21) Appl. No.: 19/368,074

(22) Filed: Oct. 24, 2025

Related U.S. Application Data
(63) Continuation-in-part of application No. 17/901,198, filed on Sep. 1, 2022.

(51) Int. Cl. B24B 23/00; B23K 9/26; B24B 19/16; B24B 23/02

(52) U.S. Cl. CPC B24B 23/005; B23K 9/26; B24B 19/16; B24B 23/028

(57) ABSTRACT

A tool includes a handle having a proximal end and a distal end, wherein the handle includes a first cylindrical cavity extending into the handle from an opening in the distal end and having a first cylindrical wall. The tool further includes a radial bearing having an inner race, an outer race, and rolling elements, wherein the outer race is secured to the first cylindrical wall of the first cylindrical cavity. Still further, the tool includes a central shaft having proximal and distal sections, wherein the proximal section is secured to the inner race, and wherein the distal section extends from the first cylindrical cavity and includes external screw threads. The tool additional includes a chuck threadably coupled to the external screw threads, wherein the chuck includes self-centering jaws for selectively gripping a tungsten electrode along an axis of rotation established by the radial bearing.

### BACKGROUND

The present disclosure relates to methods and apparatus used to sharpen a tungsten electrode for use in a welding operation.

### BACKGROUND OF THE RELATED ART

Gas tungsten arc welding (GTAW) is an arc welding process that uses a non-consumable tungsten electrode to produce the weld. Tungsten is used as an electrode because it has the highest melting temperature among pure metals, such that the tungsten electrode is not consumed during welding. An inert shielding gas, such as argon or helium, is introduced to protect the weld area and the tungsten electrode from oxidation or contamination. The gas tungsten arc welding process may also include use of a filler metal. Common materials that are welded using gas tungsten arc welding include stainless steel, aluminum, magnesium and copper alloys.

### BRIEF SUMMARY

Some embodiments provide a tool or apparatus comprising a rigid handle having a proximal end and a distal end, wherein the rigid handle includes a first cylindrical cavity extending into the rigid handle from an opening in the distal end and having a first cylindrical wall. The tool further comprises a radial bearing having an inner race, an outer race, and rolling elements disposed between the inner and outer races, wherein the outer race is secured to the first cylindrical wall of the first cylindrical cavity. Still further, the tool comprises a central shaft having a proximal section and a distal section, wherein the proximal section is secured to the inner race, and wherein the distal section extends from the first cylindrical cavity and includes external screw threads. The tool additionally comprises a chuck threadably coupled to the external screw threads included on the distal section of the central shaft, wherein the chuck includes self-centering jaws for selectively gripping a tungsten electrode along an axis of rotation established by the radial bearing.

Some embodiments provide a tool or apparatus comprising a rigid handle having a proximal end and a distal end, wherein the rigid handle includes a first cylindrical cavity extending into the rigid handle from an opening in the distal end and having a first cylindrical wall. The tool further comprises a radial bearing assembly including a plurality of radial bearings, each radial bearing having an inner race, an outer race, and rolling elements disposed between the inner and outer races, wherein the outer race of each of the radial bearings is secured to the first cylindrical wall of the first cylindrical cavity. Still further, the tool comprises a central shaft having a proximal section and a distal section, wherein the proximal section is secured to the inner race, and wherein the distal section extends from the first cylindrical cavity and includes external screw threads. The tool additionally comprises a chuck threadably coupled to the screw threads of the central shaft, wherein the chuck includes self-centering jaws for selectively gripping a tungsten electrode along an axis of rotation established by the radial bearing assembly.

### BRIEF DESCRIPTION OF THE SEVERAL VIEWS OF THE DRAWINGS

FIG. 1 is a diagram of a tool being used with an angle grinder to sharpen a tungsten electrode for use in welding.

FIG. 2 is an assembly view of the tungsten sharpening tool according to a first embodiment.

FIGS. 3A-C are cross-sectional side views of a bearing assembly that allows the chuck to rotate while a handle of the tungsten sharpening tool is held by a user according to the first embodiment.

FIGS. 4A-C are perspective views of the handle with an internal storage compartment for storing additional tungsten electrodes.

FIGS. 5A-B include an assembly view and an assembled view of the tungsten sharpening tool according to a second embodiment.

FIGS. 6A-D are cross-sectional side views of a bearing assembly according to the second embodiment.

### DETAILED DESCRIPTION

Some embodiments provide a tool or apparatus comprising a rigid handle having a proximal end and a distal end, wherein the rigid handle includes a first cylindrical cavity extending into the rigid handle from an opening in the distal end and having a first cylindrical wall. The tool further comprises a radial bearing having an inner race, an outer race, and rolling elements disposed between the inner and outer races, wherein the outer race is secured to the first cylindrical wall of the first cylindrical cavity. Still further, the tool comprises a central shaft having a proximal section and a distal section, wherein the proximal section is secured to the inner race, and wherein the distal section extends from the first cylindrical cavity and includes external screw threads. The tool additionally comprises a chuck threadably coupled to the external screw threads included on the distal section of the central shaft, wherein the chuck includes self-centering jaws for selectively gripping a tungsten electrode along an axis of rotation established by the radial bearing.

The rigid handle may have any of a wide variety of shapes that are convenient or comfortable to hold in a person's hand, such as a cylindrical shape. For example, a cylindrical handle may have a central axis that is aligned with the axis of rotation. The rigid handle is preferably made with a strong and durable material, such as a metal, for use in a welding environment. In one option, the rigid handle may be made from a single, solid piece of aluminum. Accordingly, features of the rigid handle, such as the first cylindrical cavity, may be machined into the rigid handle or the entire rigid handle may be formed in a casting process.

The first cylindrical cavity may be characterized by the first cylindrical wall that receives the outer race of the radial bearing. Accordingly, the first cylindrical wall may be only slightly larger in diameter than the radial bearing. For example, a thin layer of an adhesive material may be applied between an outer cylindrical surface of the radial bearing and the first cylindrical wall, then allowed to set up and prevent the radial bearing from coming out of the first cylindrical cavity. Notable, the forces applied to the radial bearing during use of the tool do not tend to pull on the radial bearing in a distal direction.

In some embodiments, the first cylindrical cavity may include an inwardly extending cylindrical shoulder that is located a predetermined distance from the distal opening to register the position of a proximal end of the outer race. In addition, the central shaft may include an outwardly extending cylindrical shoulder that is located a predetermined distance from a proximal end of the central shaft to register the position of a distal end of the inner race. Accordingly, the outer race may be positioned against the inwardly extending cylindrical shoulder and the inner race may be positioned against the outwardly extending cylindrical shoulder to prevent the central shaft from contacting any portion of the rigid handle.

In some embodiments, a proximal end of the central shaft may be externally threaded to threadably receive a threaded nut. The threaded nut may be tightened to press against a proximal end of the inner race and thereby secure the distal end of the inner race against the outwardly extending cylindrical shoulder. With the threaded nut secured to the external threads on the proximal end of the central shaft, the central shaft and the radial bearing form an assembly that may be inserted into the first cylindrical cavity as a single member. The first cylindrical cavity should be long enough to avoid contact with the threaded nut, which should turn freely along with the central shaft.

In some embodiments, the radial bearing may be replaced with a plurality of radial bearings positioned in side-by-side contact along the central shaft. The plurality of radial bearings may be retained on the central shaft with the threaded nut. The inner races of the radial bearing may be in frictional engagement with the inner race(s) of any adjacent radial bearing, the outwardly extending shoulder, and/or the threaded nut. Furthermore, the outer races of the radial bearing may be in frictional engagement with the outer race(s) of any adjacent radial bearing and/or the inwardly extending shoulder. However, there should be nothing that prevents the inner races of the radial bearings from turning freely relative to, and within, the outer races. The number of radial bearings may vary as needed, but some embodiments desirable include 3-5 radial bearings and some embodiments are shown in the Figures having four radial bearings.

Embodiments of the central shaft include a distal section with external screw threads for threadably coupling a chuck. Optionally, a distal end of the distal section of the central shaft may include a threaded hole for receiving a screw to further secure the chuck to the central shaft. The chuck itself may have any of wide variety of mechanisms for self-centering jaws for selectively gripping a tungsten electrode along an axis of rotation established by the radial bearing. The chuck could be keyed or keyless.

In some embodiments, the rigid handle may include a second cylindrical cavity extending into the rigid handle from an opening in the proximal end. Preferably the rigid handle will include an internal wall that separates the first cylindrical cavity from the second cylindrical cavity. While the first cylindrical cavity receives and secures the radial bearing and central shaft, the second cylindrical cavity is intended to provide a storage compartment for securing a plurality of extra tungsten electrodes. A cap may be selectively securable to a proximal end of a main handle body in order to close off the second cylindrical cavity and retain the extra tungsten electrodes during use or transport of the tool. For example, the proximal end of the main handle body may include first cylindrical threads and the cap may include second cylindrical threads for threadably coupling to the first cylindrical threads. The cap is preferably made from the same material as the rest of the rigid handle.

In some embodiments, the second cylindrical cavity may be at least 3⅜ (3.375) inches long from the internal wall to the inside of the cap when the cap is secured to the proximal end of the main handle body. Depending upon the diameter of the rigid handle, the second cylindrical cavity may hold from 5 to 10 or more tungsten electrodes having a ⅛-inch diameter.

Some embodiments may include a bearing housing to secure the bearings in the first cylindrical cavity of the rigid handle. Beneficially, the use of the bearing housing may negate the need for an adhesive to secure the bearings. Not only is the bearing housing more secure than the adhesive, but it simplifies the replacement of a bearing or bearing assembly whether or not there is a single bearing or a plurality of bearings. For example, the tool or apparatus may comprise a bearing housing having an inner cylindrical surface, an outer cylindrical surface, an inwardly directed shoulder at a distal end of the inner cylindrical surface, and external threads at a proximal end of the outer cylindrical surface, wherein the first cylindrical wall in the rigid handle includes internal threads for threadably securing the external threads of the bearing housing.

In some embodiments having a bearing housing, the outer race of the radial bearing may be secured against the inner cylindrical surface with a distal end of the outer race positioned against the inwardly directed shoulder of the bearing housing. Furthermore, a proximal end of the outer race may be positioned against the inwardly extending cylindrical shoulder of the first cylindrical cavity. Tightening the external threads of the bearing housing with the internal threads of the rigid handle causes the outer race of the bearing housing to the become gripped between the inwardly directed shoulder of the bearing housing and the inwardly extending cylindrical shoulder of the first cylindrical cavity.

In some embodiments having a bearing housing, the proximal section of the central shaft may include an outwardly extending cylindrical shoulder, wherein a distal end of the inner race is positioned against the outwardly extending cylindrical shoulder. Furthermore, a proximal end of the central shaft may be externally threaded to threadably receive a threaded nut, wherein the threaded nut is tightened against a proximal end of the inner race and secures the inner race with the distal end of the inner race against the outwardly extending cylindrical shoulder.

Some embodiments provide a tool or apparatus comprising a rigid handle having a proximal end and a distal end, wherein the rigid handle includes a first cylindrical cavity extending into the rigid handle from an opening in the distal end and having a first cylindrical wall. The tool further comprises a radial bearing assembly including a plurality of radial bearings, each radial bearing having an inner race, an outer race, and rolling elements disposed between the inner and outer races, wherein the outer race of each of the radial bearings is secured to the first cylindrical wall of the first cylindrical cavity. Still further, the tool comprises a central shaft having a proximal section and a distal section, wherein the proximal section is secured to the inner race, and wherein the distal section extends from the first cylindrical cavity and includes external screw threads. The tool additionally comprises a chuck threadably coupled to the screw threads of the central shaft, wherein the chuck includes self-centering jaws for selectively gripping a tungsten electrode along an axis of rotation established by the radial bearing assembly. The foregoing tool may further include any one or more features or components described herein in reference to any other embodiment of the tool.

It should be recognized that embodiments described as having a single bearing may also be used with a plurality of bearings by the simple substitution. Accordingly, any reference to the proximal or distal end of the bearing should be interpreted as also referring to the proximal or distal end of the plurality of bearings, which are stacked against each other. Therefore, the proximal end of the most proximal bearing in a plurality of bearings may function similar to the proximal end of a single bearing and the distal end of the most distal bearing in a plurality of bearings may function similar to the distal end of a single bearing. This is the case for both the inner race and the outer race.

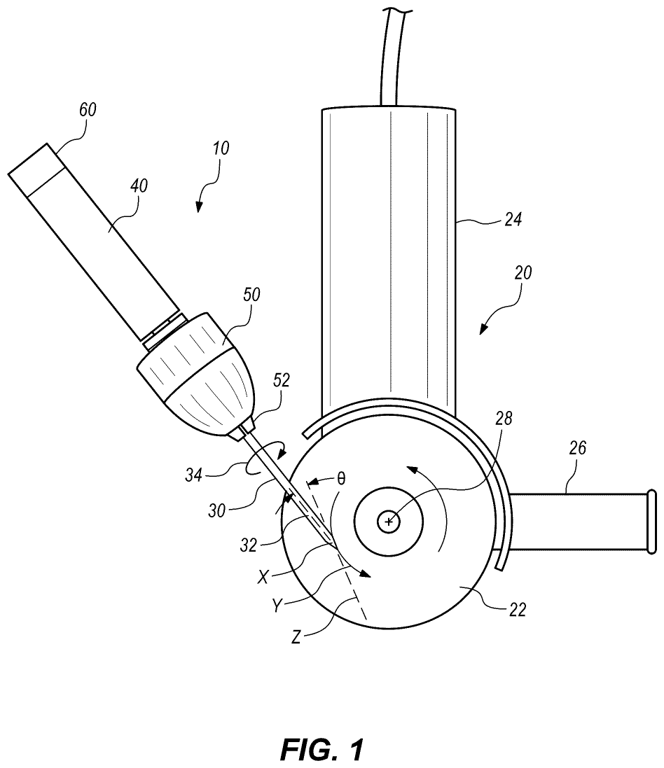

FIG. 1 is a diagram of a tool 10 being used with an angle grinder 20 to sharpen a tungsten electrode 30 for use in a welding operation. The tool 10 includes a main handle body 40, a cap 60 and a chuck 50 that is rotationally mounted to a distal end of the main handle body 40. The tungsten electrode 30 is secured into the jaws 52 of the chuck 50 and a user then uses the tool 10 to position the distal end of the tungsten electrode 30 at a slight angle relative to the plane of the angle grinder wheel 22. The angle grinder 20 may be held in place by securing a main handle or motor housing and/or an auxiliary handle 26, while a motor causes the angle grinder wheel 22 to spin about an axis 28 (counterclockwise in this illustration; see the rotational arrow).

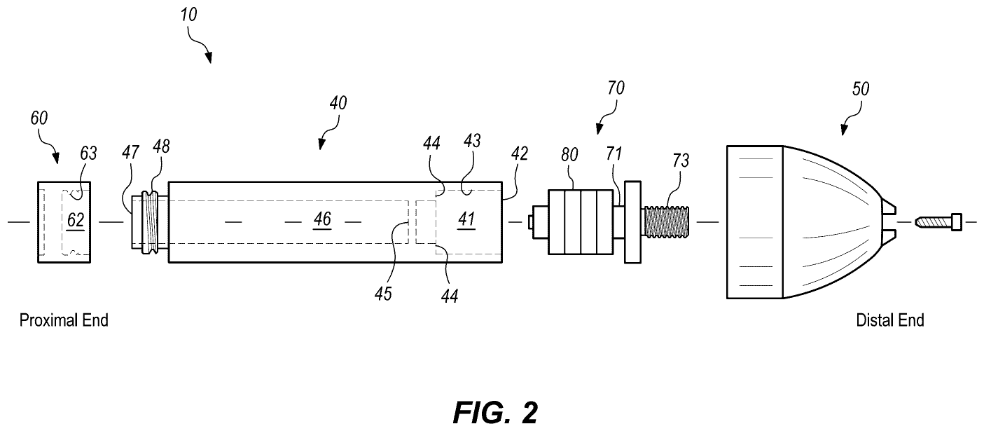

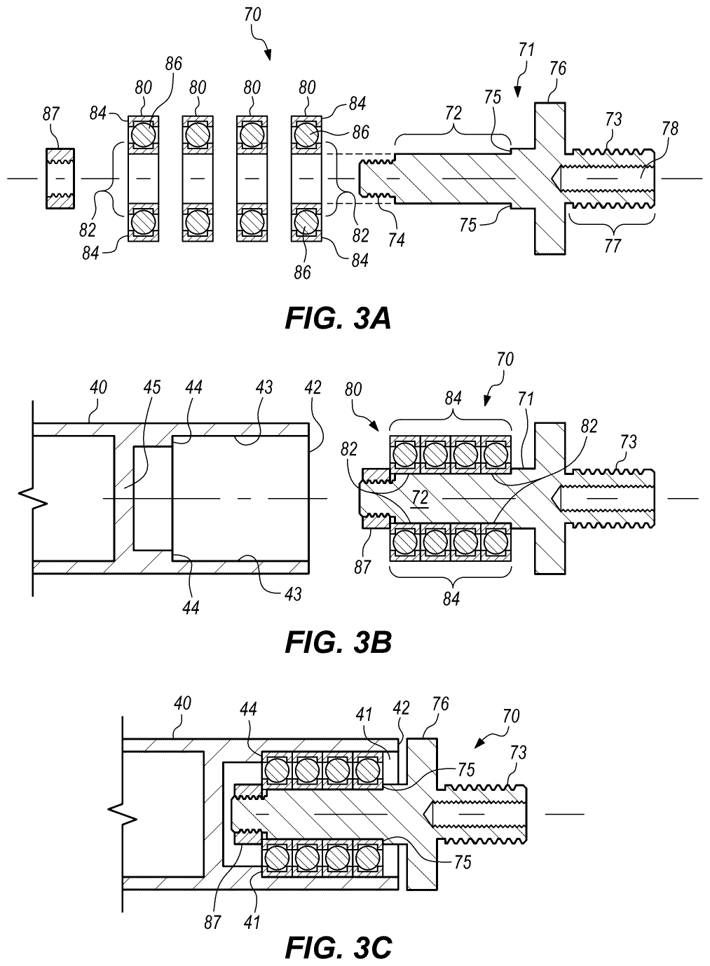

The tungsten electrode 30 may be held at a first angle relative to the plane of the angle grinder wheel 20 into order to establish the point on the distal tip of the tungsten electrode 30. For example, if the angle grinder wheel 20 is spinning in the plane of the page of FIG. 1, then a person would hold the main handle body 40 at a particular angle of X degrees (into the page) in order to grind the tungsten electrode 30 to a point that forms an X-degree angle with the sides of the tungsten electrode 30. The main handle body 40 is preferably also angled relative to the tangent of the angle grinder wheel 20 at the point where the tungsten electrode 30 is making contact with the angle grinder wheel 20. So, in FIG. 1, the tungsten electrode 30 is making contact with the angle grinder wheel 20 near a point X, the rotation of the angle grinder wheel 20 is indicated by the curved arrow Y, the curve traversed by the curved arrow Y has a tangent line Z (dashed line), and the tungsten electrode 30 has a central axis 32. The angle θ between the central axis 32 of the tungsten electrode 30 and the tangent line Z is some non-zero, acute angle, such that the rotation of the angle grinder wheel 20 (in the counter-clockwise direction as illustrated) will impart rotation to the tungsten electrode 30 (as illustrated by the arrow 34) since the chuck 50 is mounted to the main handle body 40 by a radial bearing (not shown; but see FIGS. 2-3). Accordingly, the entire circumference of the tungsten electrode 30 will be ground to the same angle θ.

FIG. 2 is an assembly view of the tool 10. Starting from the left side of the diagram, the tool 10 includes a cap 60 that forms a proximal end of the tool, a main handle body 40, a central shaft/bearing assembly 70 and the chuck 50. These components are to be assembled along an axial centerline to form the tool 10 as shown in FIG. 1. The main handle body 40 and the cap 60 may be referred to collectively as the “handle.”

The main handle body 40 includes a first cylindrical cavity 41 that extends into the main handle body 40 from an opening 42 in the distal end of the main handle body and has a first cylindrical wall 43. The first cylindrical cavity 41 further includes an inwardly extending cylindrical shoulder 44 that is located a predetermined distance from the distal opening 42. A wall 45 separates the first cylindrical cavity 41 from a second cylindrical cavity 46 that extends into the main handle body 40 from an opening 47 in the proximal end of the main handle body 40. The proximal end of the main handle body 40 has external threads 48 adjacent the opening 47. The cap 60 has a recess or cavity 62 with internal threads 63 that mate with the external threads 48 to selectively close off the second cylindrical cavity 46.

The central shaft/bearing assembly 70 is to be secured inside the first cylindrical cavity 41 in a manner that allows the central shaft 71 to turn freely about its axis. The relationships between the central shaft 71, the radial bearing(s) 80 and the first cylindrical cavity 41 are described in greater detail in reference to FIGS. 3A-C. However, the distal end of the central shaft 71 has external screw threads 73 for threadably coupling and securing the chuck 50. After securing the chuck 50 to the central shaft 71, the further screw 51 may be coupled into an internally thread hole in the distal end of the central shaft (shown in FIGS. 3A-C). The chuck preferably includes self-centering jaws for selectively gripping a tungsten electrode along an axis of rotation established by the central shaft/bearing assembly 70.

FIGS. 3A-C are cross-sectional side views of a central shaft/bearing assembly 70 that allows the chuck to rotate while a handle of the tool is held by a user. FIG. 3A shows a set of four radial bearings 80, each radial bearing 80 including an inner race 82, an outer race 84, and rolling elements 86 disposed between the inner and outer races. The inner race 82 defines an inner diameter opening that is received onto the central shaft 71.

The central shaft 71 includes a proximal section that forms a main cylindrical shaft 72 for receiving the radial bearing(s) 80. Once the radial bearing(s) 80 are in place, the radial bearing(s) 80 may be secured by attaching the threaded nut 87 to the threads 74 on the proximal end of the central shaft 71. The central shaft 71 further includes an outwardly extending cylindrical shoulder 75 that is located a predetermined distance from the proximal end of the central shaft. The outwardly extending cylindrical shoulder 75 registers the position of a distal end of the inner race 82. A collar 76 preferably has a diameter equal to that of the main handle body 40 (see FIG. 2) to protect the bearings from dirt and debris, and perhaps also to protect the user against a pinch point between the handle and the chuck. The distal section 77 extends from the first cylindrical cavity and includes the external screw threads 73. Optional internal screw threads 78 may also be provided to further secure the chuck to the central shaft 71.

FIG. 3B illustrates the central shaft/bearing assembly 70 ready to be inserted into the first cylindrical cavity 41. The first cylindrical cavity 41 has the first cylindrical wall 43 that receives the outer race 84 of the radial bearing(s) 80. Accordingly, the first cylindrical wall 43 may be only slightly larger in diameter than the radial bearing(s) 80. The first cylindrical cavity 41 further includes an inwardly extending cylindrical shoulder 44 that is located a predetermined distance from the distal opening 42 to register the position of a proximal end of the outer race 84.

The radial bearing(s) 80 are positioned about the main cylindrical shaft 72 with the inner race 82 pressed between the outwardly extending cylindrical shoulder 75 and the nut 87. Note that the outer race 84 is free to rotate relative to the central shaft 71. Before inserting the central shaft/bearing assembly 70 into the first cylindrical cavity 41, a thin layer of an adhesive material may be applied between an outer race 84 of the radial bearing 80 and the first cylindrical wall 43. The adhesive would then be allowed to set up prior to use, so that the adhesive will prevent the central shaft/bearing assembly 70 from coming out of the first cylindrical cavity 41 (see FIG. 3C).

FIG. 3C illustrates the central shaft/bearing assembly 70 secured within the first cylindrical cavity 41. Specifically, the outer races of the radial bearing(s) are engaged with the inwardly extending shoulder 44 and adhesively secured to the cylindrical wall 43. The inner races of the radial bearing(s) may be in frictional engagement with the inner race(s) of any adjacent radial bearing, the outwardly extending shoulder 75, and/or the threaded nut 87. However, there should be nothing that prevents the inner races of the radial bearings from turning freely relative to, and within, the outer races. In particular, note that the nut 87 and distal end of the main cylindrical shaft 72 do not engage the wall 45 and that the collar 76 does not engage the distal end of the main handle body 40.

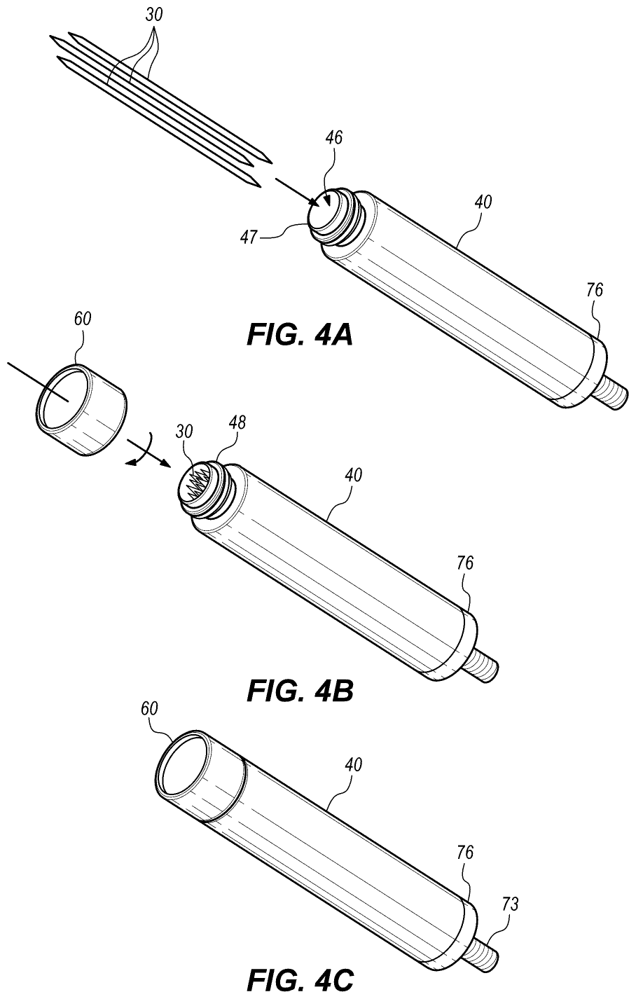

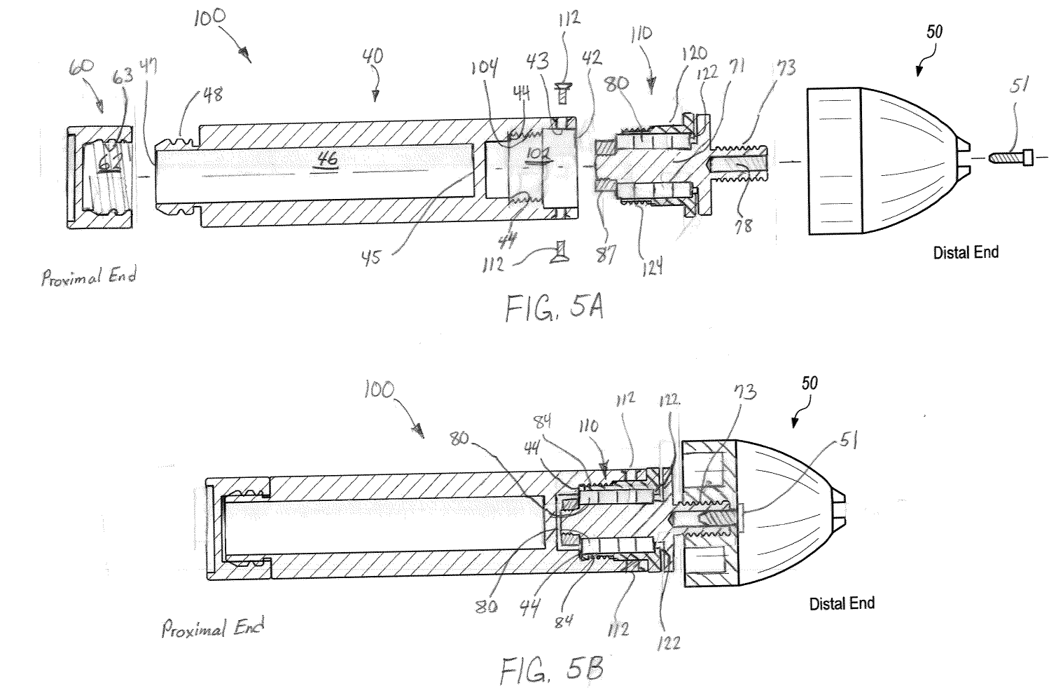

FIGS. 4A-C are perspective views of the main handle body 40 with an internal storage compartment formed in the second cylindrical cavity 46 for storing additional tungsten electrodes 30. In FIG. 4A, the main handle body 40 is shown with the second cylindrical cavity 46 extending into the main handle body 40 from an opening in the proximal end 47. A plurality of extra tungsten electrodes 30 are ready to be placed into the second cylindrical cavity 46 for storage until needed. In FIG. 4B, the tungsten electrodes 30 have been loaded into the second cylindrical cavity 46 and the cap 60 is aligned to be selectively secured to the threads 48 on the proximal end 47 of the main handle body 40 in order to close off the second cylindrical cavity and retain the extra tungsten electrodes during use or transport of the tool. Optionally, the second cylindrical cavity 46 may be at least 3.5 inches long from the internal wall 45 (see FIG. 2) to the inside of the cap 60 (see also FIG. 2) when the cap is secured to the proximal end of the main handle body. Depending upon the diameter of the main handle body 40 and the thickness of the wall around the second cylindrical cavity 46, the second cylindrical cavity may hold from 5 to 10 or more tungsten electrodes 30 having about a ⅛-inch diameter. In FIG. 4C, the cap 60 has been secured to the main handle body 40 such that the tungsten electrodes 30 are fully contained. When needed, one or more tungsten electrode 30 may be removed by removing the cap 60. However, neither the cap 60 nor the extra tungsten electrodes 30 interfere with the use of the tool 10 (see FIG. 1) for holding a tungsten electrode 30 during a sharpening operation.

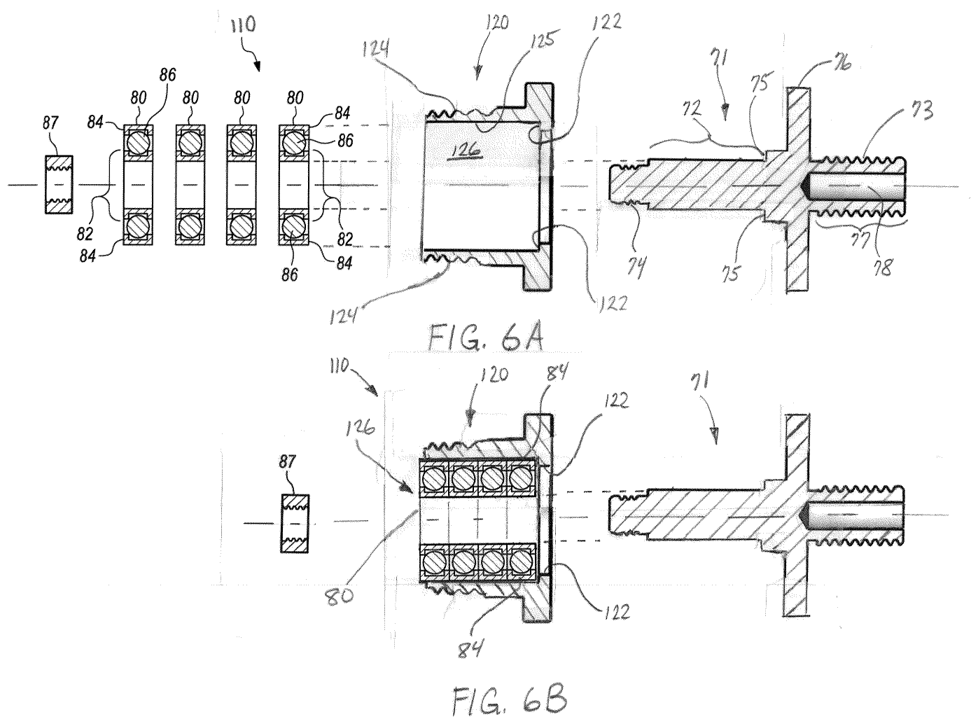

FIGS. 5A-B include an assembly view and an assembled view of a tungsten sharpening tool 100 according to a second embodiment. The tool 100 includes some similarities with the tool 10 of FIG. 2 and similar parts may be labeled with the same reference numbers as used previously in reference to tool 10.

In reference to FIG. 5A, the tungsten sharpening tool 100 includes a cap 60 that forms a proximal end of the tool, a main handle body 40, a central shaft/bearing assembly 110 and the chuck 50. These components are to be assembled along an axial centerline to form the tool 100 as shown in FIGS. 1 and 5B. The main handle body 40 and the cap 60 may be referred to collectively as the “handle.”

The main handle body 40 includes a first cylindrical cavity 102 that extends into the main handle body 40 from an opening 42 in the distal end of the main handle body 40 and has a first cylindrical wall 43. The first cylindrical cavity 102 further includes a set of internal threads 104. A wall 45 separates the first cylindrical cavity 102 from a second cylindrical cavity 46 that extends into the main handle body 40 from an opening 47 in the proximal end of the main handle body 40. The proximal end of the main handle body 40 has external threads 48 adjacent the opening 47. The cap 60 has a recess or cavity 62 with internal threads 63 that mate with the external threads 48 to selectively close off the second cylindrical cavity 46.

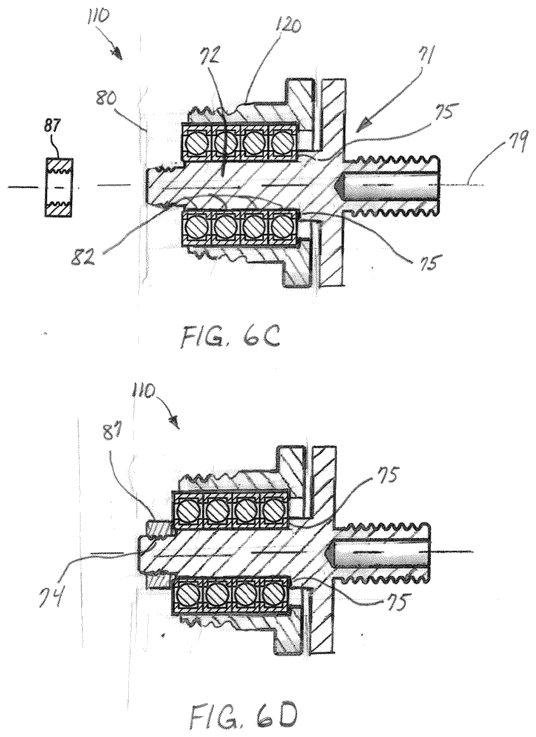

The central shaft/bearing assembly 110 is to be secured inside the first cylindrical cavity 102 in a manner that allows the central shaft 71 to turn freely about its central axis. The relationships between the central shaft 71, the radial bearing(s) 80 (four bearings shown) and the first cylindrical cavity 102 is described in greater detail in reference to FIGS. 6A-D. However, FIG. 5B shows the outer race 84 of the radial bearings 80 secured between the shoulder 122 on the bearing housing 120 and the shoulder 44 in the first cylindrical cavity 102.

The distal end of the central shaft 71 has external screw threads 73 for threadably coupling and securing the chuck 50. After securing the chuck 50 to the central shaft 71, the further screw 51 may be coupled into an internally thread hole 78 in the distal end of the central shaft 71 (shown in FIGS. 6A-D). The chuck 50 preferably includes self-centering jaws for selectively gripping a tungsten electrode along an axis of rotation established by the central shaft/bearing assembly 110.

Briefly, the central shaft/bearing assembly 110 includes a bearing housing 120, the radial bearing(s) 80, the central shaft 71, and a threaded nut 87. The central shaft/bearing assembly 110 is constructed so that the central shaft 71 and threaded nut 87 are secured the inner race of the bearing(s) 80, the outer race of the bearing(s) 80 is prevented from pulling out of the bearing housing 120 in a distal direction by an inwardly extending circumferential shoulder 122, and the bearing housing 120 is prevented from pulling out of the first cylindrical cavity 102 by engaging external threads 124 on the bearing housing 120 with the internal threads 104 in the first cylindrical cavity 102. This threaded connection 124, 104 may be used instead of applying adhesive between the bearings 80 and the cylindrical wall 43 as described in reference to the tool 10 of FIG. 2. Furthermore, the central shaft/bearing assembly 110 may be further secured within first cylindrical cavity 102 using one or more set screws 112 that prevent the external threads 124 on the bearing housing 120 from unintentionally backing out of the internal threads 104. The construction and assembly of the individual components 120, 80, 71, 87 is described in reference to FIGS. 6A-D.

FIGS. 6A-D are cross-sectional side views of a bearing assembly 110 according to the second embodiment. In FIG. 6A, the bearing assembly 110 is fully disassembled. From left to right, the components of the bearing assembly 110 include a threaded nut 87, four radial bearings 80, bearing housing 120 and central shaft 71. Each bearing 80 includes an inner race 82, an outer race 84 and a plurality of rolling elements 86 disposed between the inner and outer races. The inner race 82 defines an inner diameter opening that is sized to receive the central shaft 71 and the outer race 84 defines an outer diameter dimension that is sized to be received within an inner cylindrical surface 125 of a central cavity 126 in the bearing housing 120.

The central shaft 71 includes a proximal section that forms a main cylindrical shaft 72 for receiving the radial bearing(s) 80. The external threads 74 on the proximal end of the central shaft 71 are adapted for securing the threaded nut 87. The central shaft 71 further includes an outwardly extending cylindrical shoulder 75 that is located a predetermined distance from the proximal end of the central shaft 71. The outwardly extending cylindrical shoulder 75 registers the position of a distal end of the inner race 82. A collar 76 preferably has a diameter equal to that of the main handle body 40 (see FIG. 5A) and/or the bearing housing 120 to protect the bearings 80 from dirt and debris, and perhaps also to protect the user against a pinch point between the handle 40 and the chuck 50. The distal section 77 will extend from the first cylindrical cavity 102 and includes the external screw threads 73. Optional internal screw threads 78 may also be provided to further secure the chuck 50 (see FIGS. 5A-B) to the central shaft 71.

FIG. 6B shows the central shaft/bearing assembly 110 after the radial bearings 80 have been inserted within the central cavity 126 in the bearing housing 120. Note that the outer race 84 of the most distal bearing 80 engages the proximal face of the shoulder 122. Therefore, the bearings 80 are prevented from pulling through the bearing housing 120 in the distal direction. Also note that the collection of inner races 82 leave a central opening for receiving the main cylindrical shaft 72 of the central shaft 71.

FIG. 6C shows the central shaft/bearing assembly 110 after the main cylindrical shaft 72 of the central shaft 71 has been inserted in the proximal direction into the central opening formed by the inner races 82 of the bearings 80. Accordingly, the outer races 84 engage the bearing housing 120 and the inner races 82 engage the main cylindrical shaft 72. In this position, the central shaft 71 may spin about its central axis 79 with the inner races 82 while the bearing housing 120 are the outer races 84 may be held stationary relative to the main handle body 40 (not shown; see FIG. 5B).

FIG. 6D shows the central shaft/bearing assembly 110 after the nut 87 has been threadably secured to the external threads 74 of the central shaft 71 and tightened to firmly grip the inner races 82 between the nut 87 and the cylindrical shoulder 75. In the configuration of FIG. 6D, the central shaft/bearing assembly 110 is ready to be inserted into the first cylindrical cavity 102 in the distal end of the main handle body 40 and for the external threads 124 of the bearing housing 120 to be threadably secured to the internal threads 104 within the first cylindrical cavity 102. One the central shaft/bearing assembly 110 has been threadably secured within the first cylindrical cavity 102, the two set screws 112 may be inserted through the wall of the cavity 102 and tightened against the outer circumferential surface of the bearing housing 120 as shown in FIGS. 5A-B.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
a rigid handle having a proximal end and a distal end, wherein the rigid handle includes a first cylindrical cavity extending into the rigid handle from an opening in the distal end and having a first cylindrical wall;
a radial bearing having an inner race, an outer race, and rolling elements disposed between the inner and outer races, wherein the outer race is secured to the first cylindrical wall of the first cylindrical cavity;
a central shaft having a proximal section and a distal section, wherein the proximal section is secured to the inner race, and wherein the distal section extends from the first cylindrical cavity and includes external screw threads; and
a chuck threadably coupled to the external screw threads included on the distal section of the central shaft, wherein the chuck includes self-centering jaws for selectively gripping a tungsten electrode along an axis of rotation established by the radial bearing.

2. The apparatus of claim 1, wherein the rigid handle includes a second cylindrical cavity extending into the rigid handle from an opening in the proximal end, and wherein an internal wall separates the first cylindrical cavity from the second cylindrical cavity, further comprising:
a cap selectively securable to the proximal end to of the rigid handle.

3. The apparatus of claim 2, wherein the rigid handle is a single, solid piece of aluminum.

4. The apparatus of claim 3, wherein the cap is a single solid piece of aluminum.

5. The apparatus of claim 4, wherein the proximal end of the rigid handle has first cylindrical threads and the cap includes second cylindrical thread for threadably coupling to the first cylindrical threads.

6. The apparatus of claim 5, wherein the second cylindrical cavity is at least 3.5 inches long from the internal wall to the inside of the cap when the cap is secured to the proximal end of the rigid handle.

7. The apparatus of claim 6, wherein the second cylindrical cavity will hold 10 tungsten electrodes having a ⅛-inch diameter.

8. The apparatus of claim 1, wherein the outer race of the radial bearing is secured to the first cylindrical wall by an adhesive.

9. The apparatus of claim 1, wherein the first cylindrical cavity includes an inwardly extending cylindrical shoulder at a predetermined distance from the distal proximal opening to register the position of a proximal end of the outer race, wherein the central shaft includes an outwardly extending cylindrical shoulder at a predetermined distance from a proximal end of the central shaft to register the position of a distal end of the inner race, and wherein positioning the outer race against the inwardly extending cylindrical shoulder and the inner race against the outwardly extending cylindrical shoulder prevents the central shaft from contacting any portion of the rigid handle.

10. The apparatus of claim 9, wherein a proximal end of the central shaft is externally threaded to threadably receive a threaded nut, wherein the threaded nut is tightened against a proximal end of the inner race and secures the distal end of the inner race against the outwardly extending cylindrical shoulder.

11. The apparatus of claim 1, wherein a distal end of the distal section of the central shaft includes a threaded hole for receiving a screw to further secure the chuck to the central shaft.

12. The apparatus of claim 1, further comprising:
a bearing housing having an inner cylindrical surface, an outer cylindrical surface, an inwardly directed shoulder at a distal end of the inner cylindrical surface, and external threads at a proximal end of the outer cylindrical surface, wherein the first cylindrical wall in the rigid handle includes internal threads for threadably securing the external threads of the bearing housing.

13. The apparatus of claim 12, wherein the outer race of the radial bearing is secured against the inner cylindrical surface with a distal end of the outer race positioned against the inwardly directed shoulder of the bearing housing.

14. The apparatus of claim 13, wherein a proximal end of the outer race is positioned against the inwardly extending cylindrical shoulder of the first cylindrical cavity.

15. The apparatus of claim 14, wherein tightening the external threads of the bearing housing with the internal threads of the rigid handle causes the outer race of the bearing housing to the become gripped between the inwardly directed shoulder of the bearing housing and the inwardly extending cylindrical shoulder of the first cylindrical cavity.

16. The apparatus of claim 12, wherein the proximal section of the central shaft includes an outwardly extending cylindrical shoulder, and wherein a distal end of the inner race is positioned against the outwardly extending cylindrical shoulder.

17. The apparatus of claim 16, wherein a proximal end of the central shaft is externally threaded to threadably receive a threaded nut, wherein the threaded nut is tightened against a proximal end of the inner race and secures the inner race with the distal end of the inner race against the outwardly extending cylindrical shoulder.

18. The apparatus of claim 12, wherein a distal end of the distal section of the central shaft includes a threaded hole for receiving a screw to further secure the chuck to the central shaft.

19. An apparatus, comprising:
a rigid handle having a proximal end and a distal end, wherein the rigid handle includes a first cylindrical cavity extending into the rigid handle from an opening in the distal end and having a first cylindrical wall;
a radial bearing assembly including a plurality of radial bearings, each radial bearing having an inner race, an outer race, and rolling elements disposed between the inner and outer races, wherein the outer race of each of the radial bearings is secured to the first cylindrical wall of the first cylindrical cavity;
a central shaft having a proximal section and a distal section, wherein the proximal section is secured to the inner race, and wherein the distal section extends from the first cylindrical cavity and includes external screw threads; and
a chuck threadably coupled to the screw threads of the central shaft, wherein the chuck includes self-centering jaws for selectively gripping a tungsten electrode along an axis of rotation established by the radial bearing assembly.

20. The apparatus of claim 19, wherein the outer race of each of the radial bearings is secured to the first cylindrical wall by an adhesive.
